(19) United States
(12) Patent Application Publication
(10) Pub. No.: US 2019/0111809 A1
(43) Pub. Date: Apr. 18, 2019

(54) MOVABLE CAR SEAT

(71) Applicant: Kongyuan He, Encino, CA (US)

(72) Inventor: Kongyuan He, Encino, CA (US)

(21) Appl. No.: 16/153,997

(22) Filed: Oct. 8, 2018

Related U.S. Application Data
(60) Provisional application No. 62/572,739, filed on Oct. 16, 2017.

(51) Int. Cl. B60N 2/24; B60N 2/02

(52) U.S. Cl. CPC B60N 2/245; B60N 2/02

(57) ABSTRACT

A movable car seat movably connected to a conventional car seat backrest, the movable car seat including a main body to allow a person to sit thereupon, a telescopic pole disposed laterally within the main body to extend to allow the main body to move laterally with respect to the conventional car seat backrest, and a tilting system to allow the main body to move from a horizontal position to an angled position when the telescopic pole is extended.

### BACKGROUND

### 1. Field

The present general inventive concept relates generally to a car seat, and particularly, to a movable car seat.

### 2. Description of the Related Art

Limited mobility doesn't have to limit a person's ability to drive or get into vehicles. With new advancements, products that driving easier and safer for people with disabilities are continual entering the market.

Therefore, there is a need for a car seat that allows a person with mobility problems to easily step out from an automobile.

### SUMMARY

The present general inventive concept provides a movable car seat.

Additional features and utilities of the present general inventive concept will be set forth in part in the description which follows and, in part, will be obvious from the description, or may be learned by practice of the general inventive concept.

The foregoing and/or other features and utilities of the present general inventive concept may be achieved by providing a movable car seat movably connected to a conventional car seat backrest, the movable car seat including a main body to allow a person to sit thereupon, a telescopic pole disposed laterally within the main body to extend to allow the main body to move laterally with respect to the conventional car seat backrest, and a tilting system to allow the main body to move from a horizontal position to an angled position when the telescopic pole is extended.

The movable car seat may further include a crank disposed at a side portion of the main body and connected to a turning mechanism to cause the tilting system to move the main body from the horizontal position to the angled position in response to a turning of the crank in a first direction.

The tilting system may control the main body to move from the angled position to the horizontal position in response to another turning of the crank in a second direction.

### BRIEF DESCRIPTION OF THE DRAWINGS

These and/or other features and utilities of the present generally inventive concept will become apparent and more readily appreciated from the following description of the embodiments, taken in conjunction with the accompanying drawings of which:

FIG. 1 illustrates an angled perspective view of a movable car seat, according to an exemplary embodiment of the present general inventive concept.

### DETAILED DESCRIPTION

Various example embodiments (a.k.a., exemplary embodiments) will now be described more fully with reference to the accompanying drawings in which some example embodiments are illustrated. In the FIGURES, the thicknesses of lines, layers and/or regions may be exaggerated for clarity.

Accordingly, while example embodiments are capable of various modifications and alternative forms, embodiments thereof are shown by way of example in the figures and will herein be described in detail. It should be understood, however, that there is no intent to limit example embodiments to the particular forms disclosed, but on the contrary, example embodiments are to cover all modifications, equivalents, and alternatives falling within the scope of the disclosure. Like numbers refer to like/similar elements throughout the detailed description.

It is understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.).

The terminology used herein is for the purpose of describing particular embodiments only and is not intended to be limiting of example embodiments. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements and/or components, but do not preclude the presence or addition of one or more other features, integers, steps, operations, elements, components and/or groups thereof.

Unless otherwise defined, all terms (including technical and scientific terms) used herein have the same meaning as commonly understood by one of ordinary skill in the art to which example embodiments belong. It will be further understood that terms, e.g., those defined in commonly used dictionaries, should be interpreted as having a meaning that is consistent with their meaning in the context of the relevant art. However, should the present disclosure give a specific meaning to a term deviating from a meaning commonly understood by one of ordinary skill, this meaning is to be taken into account in the specific context this definition is given herein.

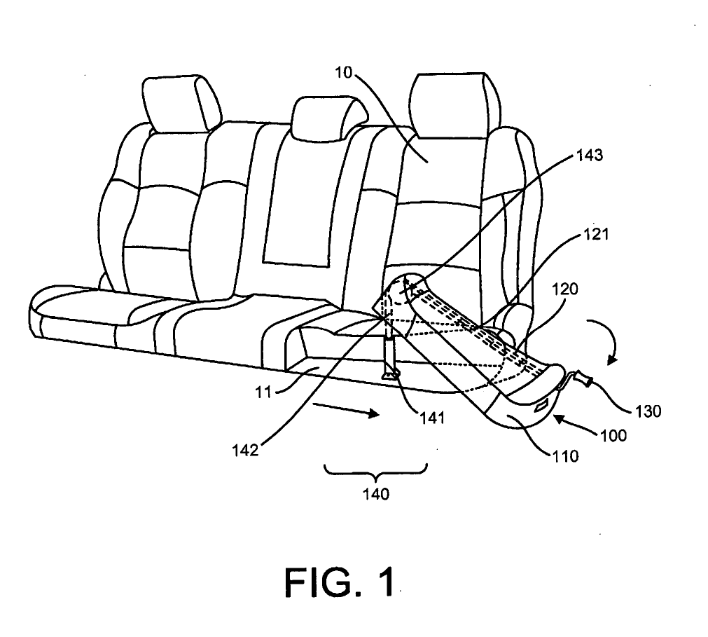

FIG. 1 illustrates an angled perspective view of a movable car seat 100, according to an exemplary embodiment of the present general inventive concept.

The movable car seat 100 may be part of a conventional car seat backrest 10, and may be movably attached to a car seat base 11.

The movable car seat 100 may include a main body 110, a telescopic pole 120, a crank 130, and a tilting system 140, but is not limited thereto.

The main body 110 may be part of at least a portion of the conventional car seat backrest 10, or alternatively, may include an entirety of the movable car seat 100.

The telescopic pole 120 may be disposed laterally inside the main body 120 in a lengthwise direction therewithin, and may allow the movable car seat 100 to move laterally left and right with respect to the conventional car seat backrest 10. Specifically, the telescopic pole 120 may extend to allow the movable car seat 100 to slide laterally with respect to the conventional car seat backrest 10. When the telescopic pole 120 is retracted, the movable car seat 100 is replaced within a car to be part of the conventional car seat backrest 10.

When the movable car seat 100 is moved laterally (i.e., the telescopic pole 120 is extended), a user may turn the crank 130 in a first direction to cause the tilting system 140 to tilt the movable car seat 100 from a horizontal position to an angled position.

The tilting system 140 may include a base 141 connected to the car seat base 11, a movable pole 142 to move up and down with respect to the base 141, and a tilt connection member 143, but is not limited thereto.

The tilting system 140 may be controlled by the crank 130, which causes a turning mechanism 121 inside the telescopic pole 120 to turn. Specifically, the crank 130 may be disposed at a side portion of the main body 110, and be connected to the turning mechanism 121.

The turning mechanism 121 may be connected to the tilt connection member 143, such that turning the crank 130 in a first direction (e.g., clockwise) causes the turning mechanism 121 to turn, which causes the tilt connection member 143 to control the movable pole 142 to move upward with respect to the base 141.

Likewise, turning the crank 130 in a second direction (e.g., counter-clockwise) causes the movable car seat 100 to move from the angled position to the horizontal position.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

1. A movable car seat movably connected to a conventional car seat backrest, the movable car seat comprising:
a main body to allow a person to sit thereupon;
a telescopic pole disposed laterally within the main body to extend to allow the main body to move laterally with respect to the conventional car seat backrest; and
a tilting system to allow the main body to move from a horizontal position to an angled position when the telescopic pole is extended.

2. The movable car seat of claim 1, further comprising:
a crank disposed at a side portion of the main body and connected to a turning mechanism to cause the tilting system to move the main body from the horizontal position to the angled position in response to a turning of the crank in a first direction.

3. The movable car seat of claim 2, wherein the tilting system controls the main body to move from the angled position to the horizontal position in response to another turning of the crank in a second direction.
